(19) United States
(12) Patent Application Publication
(10) Pub. No.: US 2025/0165659 A1
(43) Pub. Date: May 22, 2025

(54) METHOD AND APPARATUS FOR EVALUATING VULNERABILITY OF MONO-PILE FOUNDATION OF OFFSHORE WIND TURBINE

(71) Applicants: CHINA THREE GORGES CORPORATION, Wuhan, Hubei (CN); TONGJI UNIVERSITY, Shanghai (CN)

(72) Inventors: Zechao ZHANG, Wuhan, Hubei (CN); Tianpeng WANG, Wuhan, Hubei (CN); Wei ZHANG, Wuhan, Hubei (CN); Haibin XU, Wuhan, Hubei (CN); Wei WANG, Wuhan, Hubei (CN); Jie ZHANG, Wuhan, Hubei (CN); Guangming YU, Wuhan, Hubei (CN); Hao WANG, Wuhan, Hubei (CN); Zhihai CHEN, Wuhan, Hubei (CN)

(73) Assignees: CHINA THREE GORGES CORPORATION, Wuhan, Hubei (CN); TONGJI UNIVERSITY, Shanghai (CN)

(21) Appl. No.: 18/728,872

(22) PCT Filed: Jul. 10, 2023
(86) PCT No.: PCT/CN2023/106578

§ 371 Date: Jul. 13, 2024

(30) Foreign Application Priority Data
Aug. 10, 2022 (CN) 202210953396.6

(51) Int. Cl. G06F 30/13; G06F 30/23; G06F 113/06; G06F 119/02

(52) U.S. Cl. CPC G06F 30/13; G06F 30/23; G06F 2113/06; G06F 2119/02

(57) ABSTRACT

A method and apparatus for evaluating vulnerability of monopile foundations of offshore wind turbines are provided. The method includes collecting offshore wind farm location data and wind-wave characteristic data, and simulating a wind-wave time course according to the offshore wind farm location data and the wind-wave characteristic data; determining a wind-wave dynamic load based on the wind-wave course; obtaining lateral soil resistance data of monopile foundations with a plurality of rock-soil strength parameters, and inputting the wind-wave dynamic load into a 3D finite element model; using the lateral soil resistance data of monopile foundations with a plurality of rock-soil strength parameters as boundary conditions of the 3D finite element model; and giving a limit state of monopile foundations, and determining vulnerability of monopile foundations on basis of the dynamic response result of the monopile foundations and the limit state of monopile foundations.

### TECHNICAL FIELD

The present invention relates to the technical field of mono-pile foundations of offshore wind turbines, in particular to a method and apparatus for evaluating vulnerability of mono-pile foundations of offshore wind turbines.

### BACKGROUND

In recent years, as energy crises have increasingly intensified and environmental pollution problems have progressively stood out in the world, offshore wind power as a new renewable energy source has gradually become a focal point to which each country around the world has paid attention for developing new energy. At present, offshore wind turbines supported by mono-pile foundations are still most widely used as an installation for generating offshore wind power, accounting for more than 80% of the total installed capacity, in addition, the costs for constructing mono-pile foundations of offshore wind turbines is one of the important portions of the total costs for offshore wind power projects, accounting for about 30%-40% of the overall cost, in case damage occurs to the offshore wind turbines, it will cause a great loss of property and grid-connected capacity, so their reliability has attracted much attention; since dynamic factors such as waves, water currents, pulsating wind, and silting transfer exert an influence on the mono-pile foundations of offshore wind turbines, builders will face more complex scientific and engineering problems arising from constructing offshore wind farms than those from onshore wind power; in order to ensure that the mono-pile foundations for offshore wind power are reliable, it is necessary to evaluate a failure probability of mono-pile foundations at different strength load levels in the design stage of mono-pile foundations, that is, it is necessary to assess the vulnerability of the mono-pile foundations of offshore wind turbines, so as to provide guidance on design research and insurance.

At present, the builders assessing the vulnerability of the mono-pile foundations of offshore wind turbines are mainly confronted with the following problems. Assessing the vulnerability of the mono-pile foundations of offshore wind turbines still lacks a unitary standard, and a pile foundation is often designed in practice by means of a load resistance coefficient method based on approximate probability, which cannot give a failure probability of this pile foundation during a designed service period. Since wind and waves exert a long-term load force on the mono-pile foundations of offshore wind turbines, a response such as a movement or a rotation angle occurring to the pile foundation is essentially a dynamic response; however, the existing methods for analyzing the vulnerability of the mono-pile foundations of offshore wind turbines are mostly a quasi-static method, which cannot accurately reflect an actual dynamic response of pile foundations, so that it is impossible to make clear the actual reliability levels of the mono-pile foundations of offshore wind turbines. Since many uncertain factors occur in the process of naturally weathering, transferring and depositing marine soils, of which the physical and mechanical properties have great uncertainty in spatial distribution, the existing methods for analyzing the vulnerability do not explicitly consider the influence in this aspect; in addition, the uncertainty of ocean soil is often analyzed based on reliability theory, but the probability calculation method involved in reliability theory is cumbersome and difficult to apply in practice.

### SUMMARY

Therefore, the technical problem to be solved by the present invention lies in overcoming the deficiency that the existing methods for analyzing the vulnerability of the mono-pile foundations of offshore wind turbines cannot give a failure probability of this pile foundation during a designed service period, nor accurately reflect an actual dynamic response of pile foundations, nor consider the uncertainty of ocean soil, thereby providing a method and apparatus for evaluating vulnerability of mono-pile foundations of offshore wind turbines.

The present invention provides a method for evaluating vulnerability of monopile foundations of offshore wind turbines, comprising the steps of:
collecting offshore wind farm location data and wind-wave characteristic data, and simulating a wind-wave time course according to the offshore wind farm location data and the wind-wave characteristic data; the wind-wave time course including a wave-surface time course and a wind-speed time course;
determining a wind-wave dynamic load based on the wind-wave course; the wind-wave dynamic load including a wave dynamic load and a wind dynamic load;
obtaining lateral soil resistance data of monopile foundations with a plurality of rock-soil strength parameters, and inputting the wind-wave dynamic load into a 3D finite element model; using the lateral soil resistance data of monopile foundations with a plurality of rock-soil strength parameters as boundary conditions of the 3D finite element model, so as to generate a dynamic response result of monopile foundations, and
giving a limit state of monopile foundations, and determining vulnerability of monopile foundations on basis of the dynamic response result of monopile foundations and the limit state of monopile foundations;

In the above method, it is achievable to simulate the wind-wave time course based on the offshore wind farm location data and the wind-wave characteristic data, and it is able to realistically simulate the sea conditions of mono-pile foundations of offshore wind turbines, and then determine the wind-wave dynamic load based on the wind-wave time course, and obtain the dynamic response of mono-pile foundations by using the wind-wave dynamic load, so as to accurately reflect the actual dynamic response of mono-pile foundations, in addition, it is achievable to use the lateral soil resistance data of mono-pile foundations with a plurality of rock-soil strength parameters as boundary conditions of the above 3D finite element model, and take the uncertainty of marine soil into consideration, and then calculate the vulnerability of mono-pile foundations, so as to makes the vulnerability analysis of mono-pile foundations more accurate; finally, it is able to intuitively calculate a failure probability of mono-pile foundations of offshore wind turbines at different strength load levels by using the 3D finite element model during a designed service period, that is vulnerability, and then provide reliable analysis data for mono-pile foundations in different application scenarios.

Optionally, the step of simulating a wind-wave time course according to the offshore wind farm location data and the wind-wave characteristic data includes the sub-steps of:
inputting the offshore wind farm location data and the wind-wave characteristic data into a preset energy spectrum density function to generate a wave-spectrum density function and a wind-speed spectrum density function;
obtaining a wave initial phase position and a wave frequency, and generating the wave-surface time course by using the wave initial phase position, the wave frequency and the wave-spectrum density function; and
obtaining a wind-speed initial phase position and a wind-speed frequency, and generating the wind-speed time course by using the wind-speed initial phase position, the wind-speed frequency and the wind-speed spectrum density function:

In the present invention, a wind load and a wave load in a given time course can be stimulated on basis of the wind-wave energy spectrum density function, namely the wave-spectrum density function and the wind-speed spectrum density function, so as to realistically simulate the sea conditions of mono-pile foundations of offshore wind turbines, and then obtain an accurate dynamic response of mono-pile foundations.

Optionally, the sub-step of generating the wave-surface time course by using the wave initial phase position, the wave frequency and the wave-spectrum density function includes the sub-steps of:
extracting an angular frequency range from the wave-spectrum density function and equally dividing the angular frequency range into multiple wave frequency intervals;
determining a wave equal interval on basis of a upper limit and a lower limit of the angular frequency range and a number of the wave frequency intervals; and
determining the wave-surface time course on basis of the wave initial phase position, the wave frequency, the wave equal interval and the wave-spectrum density function.

Optionally, the sub-step of generating the wind-speed time course by using the wind-speed initial phase position, the wind-speed frequency and the wind-speed spectrum density function includes the sub-steps of:
extracting a pulsating wind frequency range and a wind-speed argument from the wind-speed spectrum density function and dividing the pulsating wind frequency range into multiple wind-speed frequency intervals;
determining a wind-speed equal interval on basis of a upper limit and a lower limit of the pulsating wind frequency range and a number of wind-speed frequency intervals; and
determining the wind-speed time course on basis of the wind-speed initial phase position, the wind-speed frequency, the wind-speed argument, the wind-speed equal interval and the wind-speed spectrum density function.

Optionally, the step of determining a wind-wave dynamic load based on the wind-wave course includes the sub-steps of:
obtaining an air density, a vane-sweep area and an axial conductivity coefficient, and determining a wind load exerted on a vane stress surface on basis of the air density, the vane-sweep area, the axial conductivity coefficient and the wind-speed time course;
obtaining a shape factor and a tower width, and determining a wind load exerted on a tower frame stress surface on basis of the air density, the shape factor, the tower width, and the wind-speed time course; and
generating the wind dynamic load on basis of the wind load exerted on a vane stress surface and the wind load exerted on a tower frame stress surface.

Optionally, the step of determining a wind-wave dynamic load based on the wind-wave course further includes:
obtaining a drag force, a pillar diameter, a sea water density, a horizontal water particle motion speed, a drag force coefficient, an inertial force and an inertial force coefficient, and determining the wave dynamic load on basis of the wave-surface time course, the drag force, the pillar diameter, the sea water density, the horizontal water particle motion speed, the drag force coefficient, the inertial force and the inertial force coefficient.

Optionally, in the step of determining vulnerability of monopile foundations on basis of the dynamic response result of monopile foundations and the limit state of monopile foundations, a formula for calculating the vulnerability of monopile foundations is as follows:

$$P [ ln ( EDP ) > ln ( LS ) \vert IM , Coef ] = 1 - Φ [ \frac{ln ( LS ) - {μ}_{ln ( EDP \vert IM )}}{{σ}_{ln ( EDP \vert IM )}} ]$$

in the formula, P[·] represents vulnerability of monopile foundations, EDP represents a dynamic response result of monopile foundations, LS represents a limit state of monopile foundations, IM represents a wind-wave dynamic load, Coef represents a set of calibration parameters, Φ[·] H represents a cumulative distribution function of standard normal distribution, μ ln(EDP|IM) represents a mathematical expectation of a natural logarithm of the response result of monopile foundations, σ ln(EDP|IM) represents a standard deviation of a regression curve to be calibrated.

As a second aspect of the present application, an apparatus for evaluating vulnerability of monopile foundations of offshore wind turbines is further proposed, comprising:
a simulating module used for collecting offshore wind farm location data and wind-wave characteristic data, and simulating a wind-wave time course according to the offshore wind farm location data and the wind-wave characteristic data; wherein the wind-wave time course includes a wave-surface time course and a wind-speed time course;
a determining module used for determining a wind-wave dynamic load based on the wind-wave course; wherein the wind-wave dynamic load includes a wave dynamic load and a wind dynamic load;
a generating module used for obtaining lateral soil resistance data of monopile foundations with a plurality of rock-soil strength parameters, and inputting the wind-wave dynamic load into a 3D finite element model; using the lateral soil resistance data of monopile foundations with a plurality of rock-soil strength parameters as boundary conditions of the 3D finite element model, so as to generate a dynamic response result of monopile foundations; and
a calculating module used for giving a limit state of monopile foundations, and determining vulnerability of monopile foundations on basis of the dynamic response result of monopile foundations and the limit state of monopile foundations;

Optionally, the simulating module includes:
a first simulating sub-module used for inputting the offshore wind farm location data and the wind-wave characteristic data into a preset energy spectrum density function to generate a wave-spectrum density function and a wind-speed spectrum density function;
a second simulating sub-module used for obtaining a wave initial phase position and a wave frequency, and generating the wave-surface time course by using the wave initial phase position, the wave frequency and the wave-spectrum density function; and
a third simulating sub-module used for obtaining a wind-speed initial phase position and a wind-speed frequency, and generating the wind-speed time course by using the wind-speed initial phase position, the wind-speed frequency and the wind-speed spectrum density function;

Optionally, the second simulating sub-module includes:
a first equally-dividing unit used for extracting an angular frequency range from the wave-spectrum density function and equally dividing the angular frequency range into multiple wave frequency intervals;
a first determining unit used for determining a wave equal interval on basis of a upper limit and a lower limit of the angular frequency range and a number of the wave frequency intervals, and
a first obtaining unit used for determining the wave-surface time course on basis of the wave initial phase position, the wave frequency, the wave equal interval and the wave-spectrum density function.

Optionally, the third simulating sub-module includes:
a second equally-dividing unit used for extracting a pulsating wind frequency range and a wind-speed argument from the wind-speed spectrum density function and dividing the pulsating wind frequency range into multiple wind-speed frequency intervals;
a second determining unit used for determining a wind-speed equal interval on basis of a upper limit and a lower limit of the pulsating wind frequency range and a number of wind-speed frequency intervals, and
a second obtaining unit used for determining the wind-speed time course on basis of the wind-speed initial phase position, the wind-speed frequency, the wind-speed argument, the wind-speed equal interval and the wind-speed spectrum density function.

Optionally, the determining module includes:
an obtaining sub-module used for obtaining an air density, a vane-sweep area and an axial conductivity coefficient, and determining a wind load exerted on a vane stress surface on basis of the air density, the vane-sweep area, the axial conductivity coefficient and the wind-speed time course.
a determining sub-module used for obtaining a shape factor and a tower width, and determining a wind load exerted on a tower frame stress surface on basis of the air density, the shape factor, the tower width, and the wind-speed time course; and
a calculating sub-module used for generating the wind dynamic load on basis of the wind load exerted on a vane stress surface and the wind load exerted on a tower frame stress surface.

Optionally, the determining module further includes
obtaining a drag force, a pillar diameter, a sea water density, a horizontal water particle motion speed, a drag force coefficient, an inertial force and an inertial force coefficient, and determining the wave dynamic load on basis of the wave-surface time course, the drag force, the pillar diameter, the sea water density, the horizontal water particle motion speed, the drag force coefficient, the inertial force and the inertial force coefficient.

Optionally, the calculating module includes.
a formula for calculating the vulnerability of monopile foundations is as follows:

$$P [ ln ( EDP ) > ln ( LS ) \vert IM , Coef ] = 1 - Φ [ \frac{ln ( LS ) - {μ}_{ln ( EDP \vert IM )}}{{σ}_{ln ( EDP \vert IM )}} ]$$

in the formula, P[·] represents vulnerability of monopile foundations, EDP represents a dynamic response result of monopile foundations, LS represents a limit state of monopile foundations, IM represents a wind-wave dynamic load, Coef represents a set of calibration parameters, Φ[·] represents a cumulative distribution function of standard normal distribution, μ ln(EDP|IM) represents a mathematical expectation of a natural logarithm of the response result of monopile foundations, σ ln(EDP|IM) represents a standard deviation of a regression curve to be calibrated.

As a third aspect of the present application, a computer device of predicting horizontal directional drilling-reaming torque is also proposed. The computer device comprises a processor and a memory, wherein the memory is used for storing a computer program, the computer program includes a program, and the processor is configured to call the computer program to execute the method for the first aspect of the present invention.

As a fourth aspect of the present application, a storage medium of predicting horizontal directional drilling-reaming torque is also proposed. The storage medium stores a computer program, and the computer program is executed by a processor to realize the method for the first aspect of the present invention.

### BRIEF DESCRIPTION OF THE DRAWINGS

To describe the embodiments of the present invention or the technical solutions in the prior art more clearly, the following briefly introduces the accompanying drawings required for describing the embodiments or the descriptions in the prior an. Apparently, the accompanying drawings in the following description show merely some embodiments of the present invention, and a person of ordinary skill in the art may still derive other drawings from these accompanying drawings without creative efforts.

FIG. 1 is a flow chart of the method for evaluating vulnerability of mono-pile foundations of offshore wind turbines in Example 1 of the present invention.

FIG. 2 is a flow chart of the step S101 in Example 1 of the present invention.

FIG. 3 is a flow chart of the step S1012 in Example 1 of the present invention.

FIG. 4 is a flow chart of the step S1013 in Example 1 of the present invention.

FIG. 5 is a flow chart of the step S102 in Example 1 of the present invention.

FIG. 6 is a diagram of the mono-pile foundation of offshore wind turbines and its superstructure in Example 1 of the present invention.

FIG. 7 is a diagram simulating the wave-surface time course in Example 1 of the present invention.

FIG. 8 is a diagram showing a result of calculating displacement at a mud surface in the return period for a given load in Example 1 of the present invention.

FIG. 9 is a diagram showing a probability that a mono-pile foundation exceeds a limit state per year in the return period for a given load in Example 1 of the present invention.

FIG. 10 is a principle block diagram of the apparatus for evaluating vulnerability of mono-pile foundations of offshore wind turbines in Example 2 of the present invention.

### DETAILED DESCRIPTION OF THE INVENTION

### Example 1

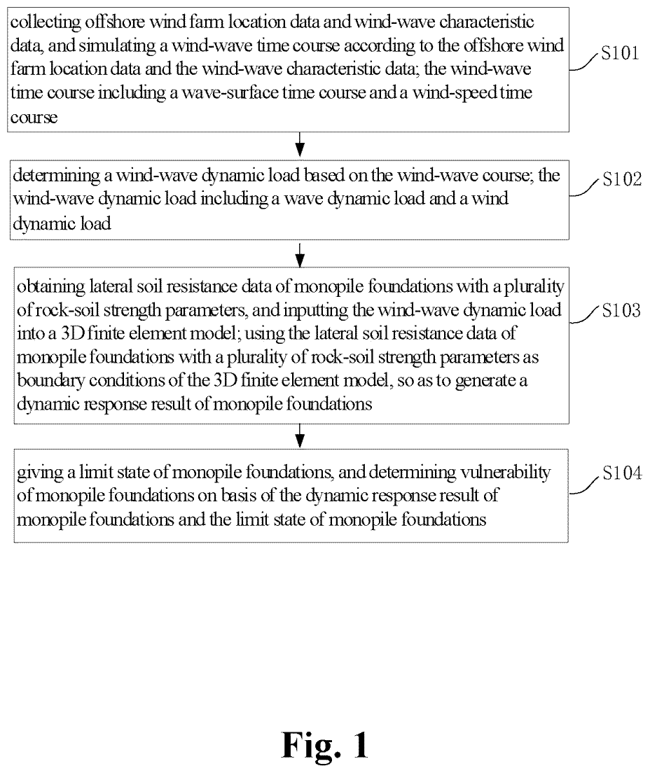

As shown in FIG. 1, a method for evaluating vulnerability of mono-pile foundations of offshore wind turbines provided by this example includes the following steps.

S101 collecting offshore wind farm location data and wind-wave characteristic data, and simulating a wind-wave time course according to the offshore wind farm location data and the wind-wave characteristic data, the above wind-wave time course including a wave-surface time course and a wind-speed time course.

Specifically, evaluating marine environmental conditions at the positions of the piles designed with mono-pile foundations, which mainly include the wind-wave characteristic data, and statistically obtaining the wind-wave characteristic data, such as an average wind-speed (V̅_{w,10}) for 10 minutes at a reference altitude and an effective wave height (Hₛ) of the wave statistics made for more than 3 hours, then establishing a relation between the return period (RP) of the wind-wave characteristic data and the wind-wave characteristic data such as V̅_{w,10} and Hₛ.

S102 determining a wind-wave dynamic load based on the above wind-wave time course:
the above wind-wave dynamic load including a wave dynamic load and a wind dynamic load.

Specifically, determining the above wind-wave dynamic load based on the above wave-surface time course, the wind dynamic load is classified into a wind load exerted on a vane stress surface and a wind load exerted on a tower frame stress surface.

S103 obtaining lateral soil resistance data of mono-pile foundations with a plurality of rock-soil strength parameters, and inputting the above wind-wave dynamic load into a 3D finite element model,
using the lateral soil resistance data of mono-pile foundations with a plurality of rock-soil strength parameters as boundary conditions of the above 3D finite element model, so as to generate a dynamic response result of mono-pile foundations.

Specifically, randomly sampling rock-soil strength parameters at the site where the dynamic response results are generated, on basis of the rock-soil strength parameter statistics and coefficients of variation of pile foundation sites of offshore wind turbines, then inputting the rock-soil strength parameter samples generated by randomly sampling into the nonlinear p-v curve method model proposed by the API norm (Rock-soil and Foundation Design Norm proposed by the American Petroleum Institute), so as to estimate the lateral soil resistance of pile foundations, and then obtain the lateral soil resistance data of mono-pile foundations with a plurality of rock-soil strength parameters;
wherein the rock-soil strength parameters include rock-soil undrained shear strength Sᵤ, effective weight μ, an internal friction angle γ′, cohesion c and so on, and the rock-soil strength parameter statistics include a mean value ϕ of rock-soil strength parameters, a coefficient of variation (COV) and so on.

Further, in line of the design parameters of the offshore wind turbine and the substructure of a wind farm planned to be constructed, establishing a three-dimensional finite element model of offshore wind turbines, tower frames and mono-pile foundations, which is used to calculate and output the dynamic response results of mono-pile foundations, in order to improve calculation efficiency, estimating stiffness of springs on basis of the lateral soil resistance of pile foundations, and replacing the rock-soil body around the pile with discrete nonlinear springs as resistance boundary conditions, and then generating a series of intensity measures (IM), and a dynamic response result of mono-pile foundations of offshore wind turbines under the conditions of the rock-soil strength parameters (that is, a dynamic response result of mono-pile foundations), next taking the dynamic response result of mono-pile foundations as an engineering demand parameters (EDP) to generate a series of IM and EDP as a calibration database;

Wherein, the rock-soil strength parameters are generated by random sampling, so that uncertainty of marine soil is fully considered.

S104 giving a limit state of mono-pile foundations, and determining vulnerability of mono-pile foundations on basis of the above dynamic response result of the mono-pile foundations and the above limit state of mono-pile foundations.

Specifically, according to norms or engineer's experience, giving a limit state (LS) of damage to mono-pile foundations of offshore wind turbines, such as a limit state of bearing capacity or a limit state of normal use, then calculating the vulnerability of the designed mono-pile foundation by the cloud analysis method, that is, a probability of exceeding the given limit state.

Further, estimating the engineering demand parameters (that is, the dynamic response results of mono-pile foundations) under the conditions of the given intensity measures (IM) on basis of a regression probability model by the Cloud Analysis method, wherein the intensity measures include wind-wave loads at different strength levels, and the engineering demand parameters include a turn angle at the mud surface of the mono-pile foundation, a horizontal displacement distance of the top of the tower frame and so on, then calibrating coefficients of the regression probability model on basis of the above intensity measures and engineering demand parameters; a calculation formula for the regression probability model is as follows.

$$E [ ln ( EDP \vert IM ) ] = {μ}_{ln ( EDP \vert IM )} = ln a + b ln ( IM )$$

$${σ}_{ln ( EDP \vert IM )} = \sqrt{\frac{{\sum }_{i = 1}^{n} {[ ln {( EDP \vert IM )}_{i} - {μ}_{ln ( EDP \vert IM ) , i} ]}^{2}}{( n - 2 )}}$$

In the above formula, E[ln(EDP|IM)] represents a mathematical expectation of a natural logarithm of the engineering demand parameter under the conditions of a given intensity measure, simplified as μ ln(EDP|IM), ln a and b represent a unknown parameter to be calibrated, σ ln(EDP|IM) represents a standard deviation of a regression curve to be calibrated, ln(EDP|IM) represents a natural logarithm of the engineering demand parameter under the conditions of a given strength parameter, n represents a number of dynamic response results output by the finite element model of mono-pile foundations.

Further, D={[IMi,(EDP|IM)i],i=1:n}, minimizing a sum of squares of the deviation by the least squares method, and then calibrating the unknown parameters ln a, b and σ ln(EDP|IM), and inputting the calibrated the parameters ln a, b and σ ln(EDP|IM) to give an estimated value of the engineering demand parameter of mono-pile foundations of offshore wind turbines under the conditions of any given strength measure, and estimating a probability of exceeding a given limit state, that is the vulnerability of mono-pile foundations. The formula for calculating the above-mentioned vulnerability of mono-pile foundations is as follows.

$$P [ ln ( EDP ) > ln ( LS ) \vert IM , Coef ] = 1 - Φ [ \frac{ln ( LS ) - {μ}_{ln ( EDP \vert IM )}}{{σ}_{ln ( EDP \vert IM )}} ]$$

In the above formula, P represents vulnerability of mono-pile foundations, EDP represents a dynamic response result of mono-pile foundations, LS represents a limit state of mono-pile foundations, IM represents a wind-wave dynamic load. Coef represents a set of calibration parameters, Coef={ln a,b, σ ln(EDP|IM), Φ[·] represents a cumulative distribution function of standard normal distribution, μ ln(EDP|IM) represents a mathematical expectation of a natural logarithm of the dynamic response result of mono-pile foundations, σ ln(EDP|IM) represents a standard deviation of a regression curve to be calibrated.

In the above method for evaluating vulnerability of mono-pile foundations of offshore wind turbines, it is achievable to simulate the wind-wave time course based on the offshore wind farm location data and the wind-wave characteristic data, and it is able to realistically simulate the sea conditions of mono-pile foundations of offshore wind turbines, and then determine the wind-wave dynamic load based on the wind-wave time course, and obtain the dynamic response of mono-pile foundations by using the wind-wave dynamic load, so as to accurately reflect the actual dynamic response of mono-pile foundations; in addition, it is achievable to use the lateral soil resistance data of mono-pile foundations with a plurality of rock-soil strength parameters as boundary conditions of the above 3D finite element model, and take the uncertainty of marine soil into consideration, and then calculate the vulnerability of mono-pile foundations, so as to makes the vulnerability analysis of mono-pile foundations more accurate; finally, it is able to intuitively calculate a failure probability of mono-pile foundations of offshore wind turbines at different strength load levels by using the 3D finite element model during a designed service period, that is vulnerability, and then provide reliable analysis data for mono-pile foundations in different application scenarios.

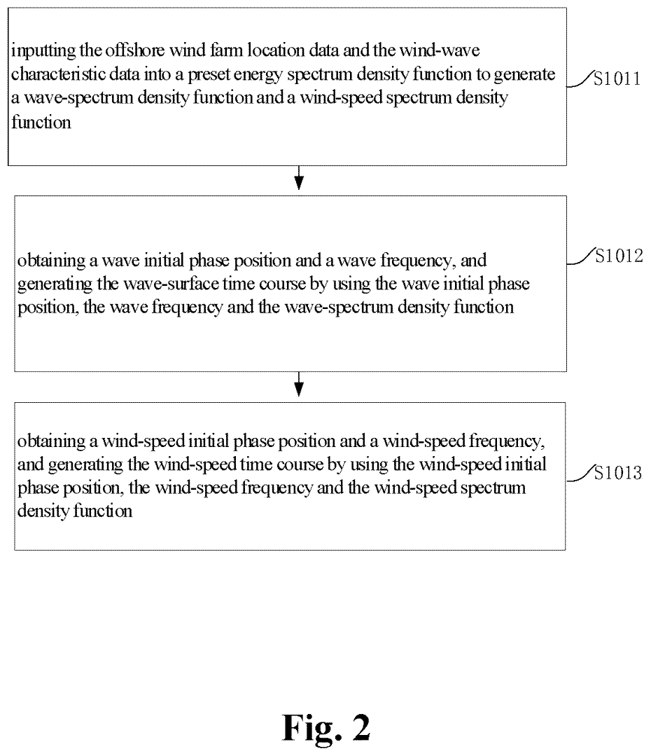

Preferably, as shown in FIG. 2, in S101 the step of simulating a wind-wave time course according to the offshore wind farm location data and the wind-wave characteristic data includes the following sub-steps.

S1011 inputting the offshore wind farm location data and the wind-wave characteristic data into a preset energy spectrum density function to generate a wave-spectrum density function and a wind-speed spectrum density function;

Specifically, obtaining a random wind-speed time course and a wave-surface time course on basis of the wave-spectrum density function and the wind-speed spectrum density function by means of the harmonic superposition method, so as to simulate an actual marine environment, wherein the wind-speed time course and the wave-surface time course are essentially a random process in a time domain.

Wherein, since the wind-speed forms a wind-speed profile along elevations, there is coherence in the wind turbulence at each elevation, thus in order to take coherence of wind into consideration, we introduce a coherence coefficient. In the case of only taking vertical coherence into consideration, the coherence coefficient Cᵢⱼ is calculated as follows.

$${C}_{ij} = exp [ - \frac{{ω}_{i} {C}_{z} \vert {z}_{i} - {z}_{j} \vert}{2 π {\overline{V}}_{w , 10} ( {z}_{i} )} ]$$

In the formula, zᵢ and zⱼ represent simulations to the elevations at point i and point j (that is, wind-wave characteristic data) in the wind-speed time course in the case of taking coherence of wind into consideration, respectively.

Further, in the case of introducing the above coherence coefficient we can calculate a wind energy spectrum density function at multiple points through the following formula.

$${S}_{w , ij} ( ω ) = \sqrt{{S}_{w , ii} ( ω ) {S}_{w , jj} ( ω )} {C}_{ij}$$

In the formula, S_{W,ij(w)} represents a cross-power spectrum density function used to take correlation of each wind-speed simulation point into consideration; S_{w,ij(w)} represents an auto-power spectrum density function at point i, and S_{w,ji(w)} represents an auto-power spectrum density function at point j.

S1012 obtaining a wave initial phase position and a wave frequency, and generating the wave-surface time course by using the wave initial phase position, the wave frequency and the wave-spectrum density function.

S1013 obtaining a wind-speed initial phase position and a wind-speed frequency, and generating the wind-speed time course by using the wind-speed initial phase position, the wind-speed frequency and the wind-speed spectrum density function.

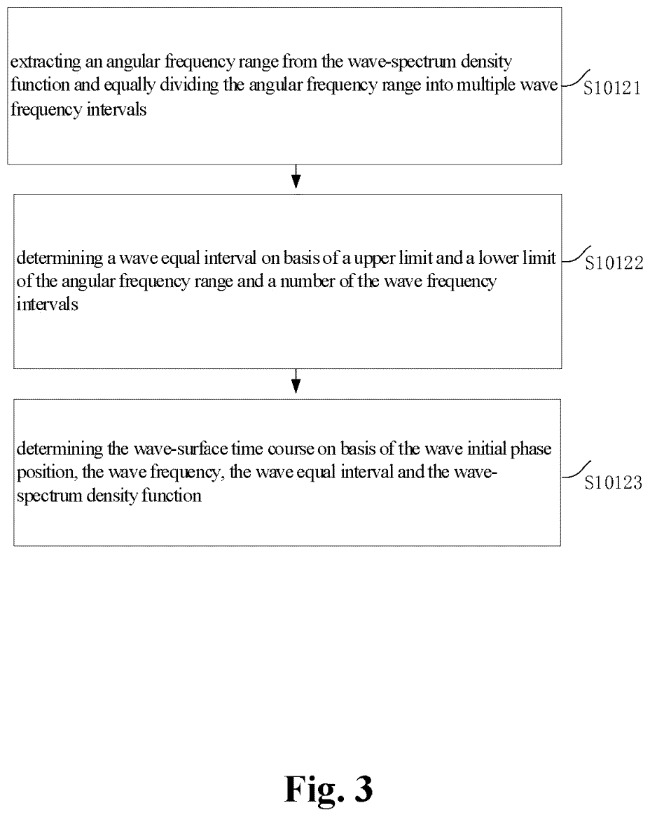

Preferably, as shown in FIG. 3, in S1012 the sub-step of generating the wave-surface time course by using the wave initial phase position, the wave frequency and the wave-spectrum density function includes the following sub-steps.

S10121 extracting an angular frequency range from the above wave-spectrum density function and equally dividing the above angular frequency range into multiple wave frequency intervals.

Specifically, providing that the angular frequency range ω_{L}˜ω_{H} is extracted from the wave-spectrum density function, dividing the angular frequency range into N₁ intervals (that is, wave frequency intervals), and setting N₁ as an appropriate positive integer (not less than 1000).

S10122, determining a wave equal interval on basis of a upper limit and a lower limit of the angular frequency range and a number of the wave frequency intervals.

Specifically, the formula for calculating the wave equal interval Δω₁ is as follows.

$$Δ {ω}_{1} = ( {ω}_{H} - {ω}_{L} ) / {N}_{1} = {ω}_{i + 1} - {ω}_{i}$$

In the above formula, ω_{H} represents a upper of an angular frequency range, ω_{L} represents a lower limit of an angular frequency range, ωᵢ˜ω₍ᵢ₊₁₎ represents a wave frequency interval.

S10123 determining the wave-surface time course on basis of the wave initial phase position, the wave frequency, the wave equal interval and the wave-spectrum density function.

Wherein, as for the simulation to the wave-surface time course, a wave surface expression at a fixed point is as follows according to a sea wave model.

$$η ( t ) = {\sum }_{n = 1}^{∞} {a}_{n} cos ( {ω}_{n} t + {ε}_{n} )$$

In the above formula, aₙ represents a wave amplitude, ωₙ represents an angular wave frequency, εₙ represents an initial phase position evenly distributed between 0˜2π, t represents simulation time.

Further, providing that the wave-spectrum density function to be simulated is S_{η} (ω), and in order to avoid periodicity, a random number \hat{ω}ᵢ is arbitrarily selected from ωᵢ˜ω₍ᵢ₊₁₎ as a frequency of the i^{th} composition wave, superimposing N₁ cosine waves representing wave energy of N₁ intervals, that is, obtaining a simulated wave-surface time course on basis of the harmonic wave superposition principle.

$$η ( t ) = {\sum }_{i = 1}^{N} \sqrt{2 {S}_{η} ( {\hat{ω}}_{i} ) Δ ω} cos ( {\hat{ω}}_{i} t + {ε}_{i} )$$

It should be noted that this wave-surface time course is a random process, in which different results will be sampled at each time of simulations made in a given time domain.

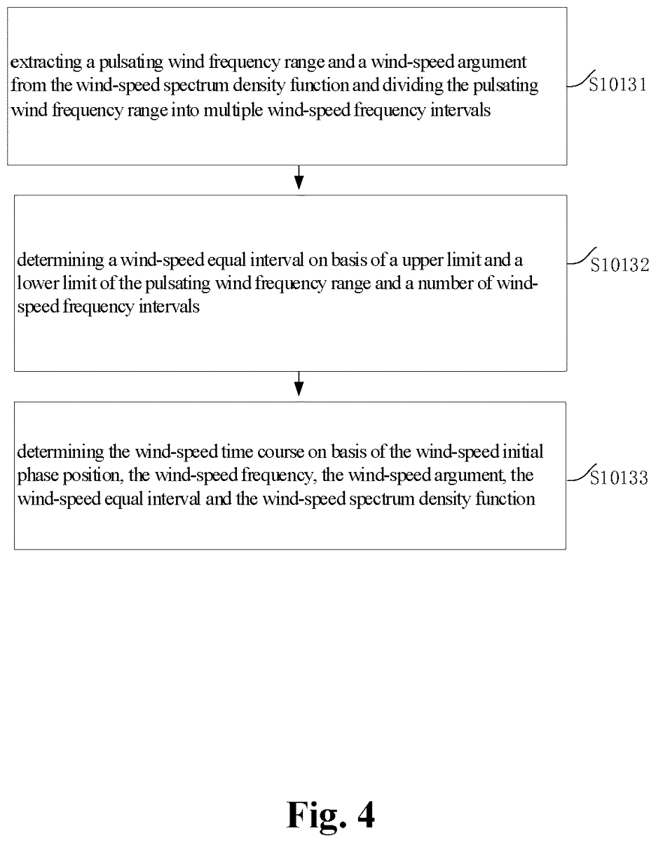

Preferably, as shown in FIG. 4, in S1013 the sub-step of generating the wind-speed time course by using the wind-speed initial phase position, the wind-speed frequency and the wind-speed spectrum density function includes the following sub-steps.

S10131 extracting a pulsating wind frequency range and a wind-speed argument from the above wind-speed spectrum density function and dividing the above pulsating wind frequency range into multiple wind-speed frequency intervals.

Specifically, dividing the pulsating wind frequency range into N₂ (not less than 1000) wind-speed frequency intervals, wherein N₂ represents a number of wind-speed frequency intervals.

S10132 determining a wind-speed equal interval on basis of a upper limit and a lower limit of the above pulsating wind frequency range and a number of wind-speed frequency intervals.

Specifically, the formula for calculating the wind-speed equal interval Δω₂, is as follows

$$Δ {ω}_{2} = ( {ω}_{u} - {ω}_{l} ) / {N}_{2}$$

In the above formula, ωᵤ represents a upper of a pulsating wind frequency range, ωₗ represents a lower limit of a pulsating wind frequency range.

S10133 determining the wind-speed time course on basis of the wind-speed initial phase position, the wind-speed frequency, the wind-speed argument, the wind-speed equal interval and the wind-speed spectrum density function.

Specifically, providing that the wind-speed spectrum density function to be simulated is S_{w}(ω), the formula for calculating the wind-speed time course is as follows on basis of the harmonic wave superposition principle.

$${V}_{w} ( t ) = \sqrt{2 ( Δ ω )} {\sum }_{m = 1}^{j} {\sum }_{l = 1}^{N} \vert {H}_{jm} ( {\hat{ω}}_{ml} ) \vert cos [ {\hat{ω}}_{ml} t + {θ}_{jm} ( {\hat{ω}}_{ml} ) + {ε}_{ml} ]$$

In the above formula, j represents a number of simulation points of the wind-speed time course, ωₘₗ˜ω_{m (l+1)} represents a wind-speed frequency range, from which a random number ωₘₗ is arbitrarily selected as the l^{th} wind spectrum composition frequency at the m^{th} simulation point, Hⱼₘ(ω) represents the Cholesky decomposition of the power spectrum density function S_{w}(ω) (the Cholesky decomposition is to express a symmetrical positive definite matrix as a lower triangular matrix L and decompose a product of its transposition). Its calculation formula is as follows.

S_{w,jm}(ω)=Hⱼₘ(ω)Hⱼₘ^{T}(ω)

In the above formula, HⱼₘT(ω) represents a transposed matrix of Hⱼₘ(ω).

Further, θⱼₘ(ω) represents an argument of Hⱼₘ(ω), its calculation formula is as follows.

$${θ}_{jm} ( ω ) = arc tan \{ \frac{Im [ {H}_{jm} ( ω ) ]}{Re [ {H}_{jm} ( ω ) ]} \}$$

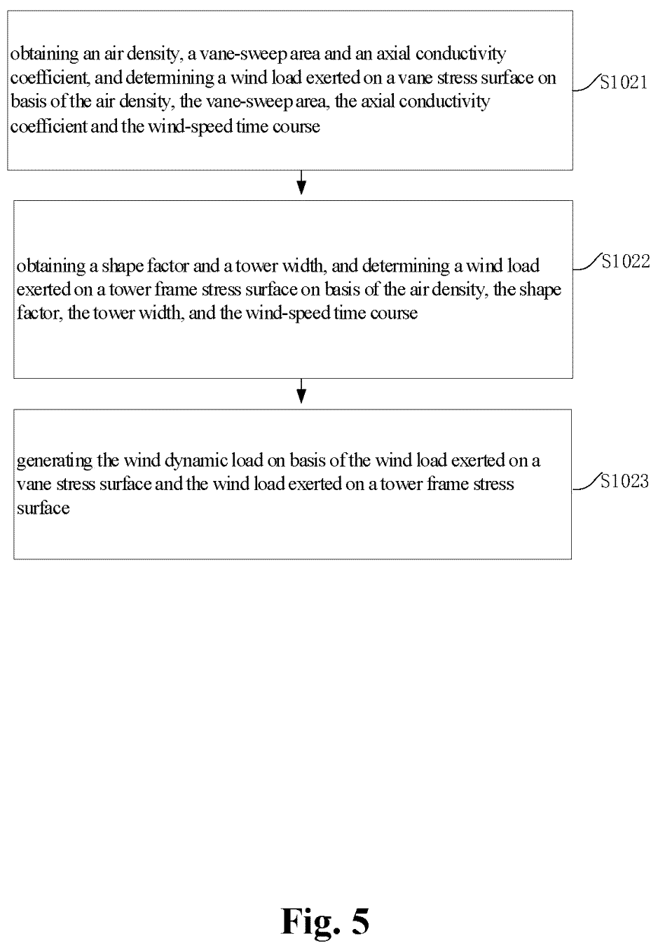

Preferably, as shown in FIG. 5, in S102 the step of determining a wind-wave dynamic load based on the above wind-wave time course includes the following sub-steps.

S1021, obtaining an air density, a vane-sweep area and an axial conductivity coefficient, and determining a wind load exerted on a vane stress surface on basis of the air density, the vane-sweep area, the axial conductivity coefficient and the wind-speed time course.

Wherein, the wind load exerted on a vane stress surface is calculated by the following formula.

$${F}_{wind , R} = \frac{1}{2} {ρ}_{a} {A}_{R} {C}_{T} {V}_{w , hub}^{2}$$

In the above formula, F_{wind,R} as represents a wind load exerted on a vane stress surface, C_{T} represents an axial conductivity coefficient, ρₐ represents an air density, A_{R} represents a vane-sweep area, V_{w,hub} represents a wind-speed time course acting at a wheel hub of a wind turbine.

S1022 obtaining a shape factor and a tower width, and determining a wind load exerted on a tower frame stress surface on basis of the air density, the shape factor, the tower width, and the wind-speed time course.

Wherein, the wind load exerted on a tower frame stress surface is calculated by the following formula.

$${F}_{wind , T} = {\int }_{0}^{{h}_{t}} \frac{1}{2} {ρ}_{a} {{C}_{s} [ {V}_{w} ( z ) ]}^{2} D ( z ) dz$$

In the above formula, F_{wind,T} represents a wind load exerted on a tower frame stress surface, Cₛ represents a shape factor, D represents a tower width, z represents a distance between a tower frame and a water level, V_{w}(z) represents a wind-speed time course acting at a tower frame.

S1023 generating the above wind dynamic load on basis of the above wind load exerted on a vane stress surface and the above wind load exerted on a tower frame stress surface.

Specifically, adding the above wind load exerted on a vane stress surface to the above wind load exerted on a tower frame stress surface, so as to generate the wind dynamic load.

Preferably, in S102, the step of determining a wind-wave dynamic load based on the above wind-wave time course further includes:

S1024 obtaining a drag force, a pillar diameter, a sea water density, a horizontal water particle motion speed, a drag force coefficient, an inertial force and an inertial force coefficient, and determining the wave dynamic load on basis of the wave-surface time course, the drag force, the pillar diameter, the sea water density, the horizontal water particle motion speed, the drag force coefficient, the inertial force and the inertial force coefficient.

Specifically, providing that the action of the wave on the pillar is mainly caused by viscous effect and additional mass effect, that is, the wave force acting on the pillar is composed of two parts: one is an inertial force proportional to acceleration, and the other is a drag force proportional to the square of speed, thus the wave dynamic load is calculated by the following formula.

$${F}_{Wave} = {\int }_{0}^{{d}_{w}} ( {f}_{D} + {f}_{I} ) dz = {\int }_{0}^{{d}_{w}} ( \frac{1}{2} {C}_{D} ρ {D}_{p} {u}_{x} \vert {u}_{x} \vert + {C}_{M} ρ \frac{π {D}_{p}^{2}}{4} \frac{\partial {u}_{x}}{\partial t} ) dz$$

In the above formula, f_{D} represents a drag force, Dₚ represents a pillar diameter, ρ represents a sea water density, [symbol] _{X} represents a horizontal water particle motion speed, C_{D} represents a drag force coefficient, f_{I} represents an inertial force and C_{M} represents an inertial force coefficient,

$$\frac{\partial {u}_{x}}{\partial t}$$

represents horizontal water particle motion acceleration.

Wherein, based on the linear wave theory, the formula for calculating the horizontal water particle motion speed [symbol] _{X} is as follows.

$${u}_{x} = \frac{2 π}{T} \frac{cosh kz}{sinh {kd}_{w}} η$$

In the above formula, k represents a number of waves, η represents a wave-surface time course, d_{w} represents a water depth, T represents a wave cycle.

Wherein, the formula for calculating horizontal water particle motion acceleration

$$\frac{\partial {u}_{x}}{\partial t}$$

is as follows

$$\frac{\partial {u}_{x}}{\partial t} = \frac{4 {π}^{2}}{{T}^{2}} \frac{cosh kz}{sinh {kd}_{w}} η tan ( \frac{2 π t}{T} - kx )$$

In the above formula, t represents a simulation time length for the wave-surface time course. X represents a position of the simulation point.

Furthermore, it is able to obtain the wind-wave dynamic loads during different return periods of the wind-wave characteristic data on basis of the relation between the return periods of the above-mentioned wind-wave characteristic data and the wind-wave characteristic data such as V̅_{w,10} and Hₛ by adopting the above processing method.

We shall take a mono-pile foundation of an offshore wind turbine as an example to describe the method for evaluating vulnerability of mono-pile foundations of offshore wind turbines.

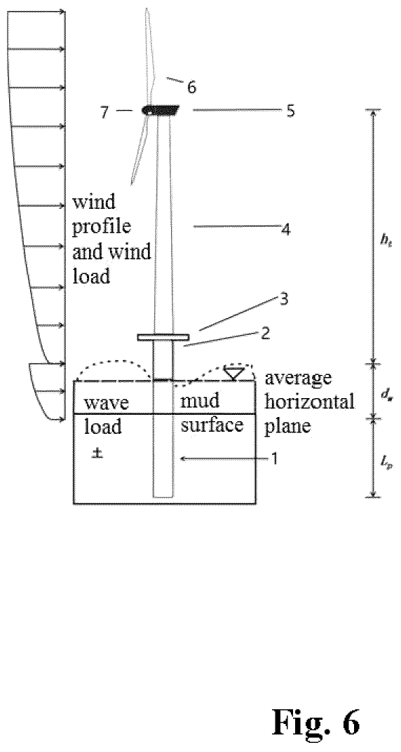

FIG. 6 shows parts and components of the offshore wind turbine, wherein 1 represents a mono-pile foundation, 2 represents a connecting section, 3 represents a platform, 4 represents a tower frame, 5 represents a machinery space, 6 represents a vane and 7 represents a wheel hub; the above FIG. 6 indicates that a mono-pile foundation of an offshore wind turbine and its superstructure are subjected to the co-action of wind-wave loads. Their main measurements are as follows. The pile foundation embedding depth Lₚ is 24 m (m), the pile diameter ID is 6.2 m, the average wall thickness t is 80 mm (mm), the wind wheel radius of the 5 MW (megawatt) three-vane wind turbine is 63 m, the wheel hub radius is 1.8 m, the vertical distance from the average surface to the wheel hub ht is 85 m, the tower bottom diameter is 5.6 m, the top diameter is 4 m, the average wall thickness is 60 mm, and the average water depth d_{w} is 25 m; the material used for the tower and mono-pile foundation is steel, of which the elastic modulus is 210 GPa (Pa) and the density is 7850 kg/m³ (kg/m³). The steps to analyzing vulnerability of mono-pile foundations of offshore wind turbines by using the above parameters are as follows.

(1) After early monitoring, the relation between the wind-wave characteristics data of the marine environment where the mono-pile foundations are located and the return period is shown in the following formulas

$${H}_{s} = 0.479 ln ( RP ) + 6.063$$

$${\overline{V}}_{w , hub} = 2.645 ln ( RP ) + 31.695$$

In the above formulas, Hₛ represents an effective wave height (m), V̅_{w,10} represents an average wind-speed (m/s) for 10 minutes at a wind turbine, RP represents a return period (years).

(2) The wave-spectrum adopts a JONSWAP spectrum density function (random wave spectrum) proposed by the DNV-OS-J101 Norm, and its expression is as follows.

$${S}_{η} ( f ) = \frac{{ag}^{2}}{{( 2 π )}^{4}} {f}^{- 5} exp [ - \frac{5}{4} {( \frac{f}{{f}_{p}} )}^{- 4} ] {γ}^{exp [ - 0.5 {( \frac{f - {f}_{p}}{σ \cdot {f}_{p}} )}^{2} ]}$$

$$a = 5 \cdot ( {H}_{s}^{2} {f}_{p}^{4} / {g}^{2} ) \cdot ( 1 - 0.287 ln γ ) \cdot {π}^{4}$$

In the above expression, a represents a Phillips constant, g represents gravitational acceleration (m/s), f represents a spectrum frequency (Hz), fₚ represents a peak spectrum frequency (Hz), s represents a peak shape parameter, g represents a peak elevation factor, and relevant parameters are set with values in light of the DNV-OS-J101 Norm.

The wave-spectrum adopts a Kaimal spectrum density function proposed by the DNV-OS-J101 Norm, and its expression is as follows

$${S}_{w} ( f ) = \frac{{σ}_{V}^{2} ( \frac{4 {L}_{k}}{{\overline{V}}_{w , 10}} )}{{( 1 + \frac{6 {fL}_{k}}{{V}_{w , 10}} )}^{\frac{5}{3}}}$$

In the above expression, σ_{V} represents a standard deviation of wind speed (m/s), and Lₖ represents a turbulence integral scale, V_{w,10} represents an average wind-speed for 10 minutes at an input wind turbine, that is V̅_{w,hub}.

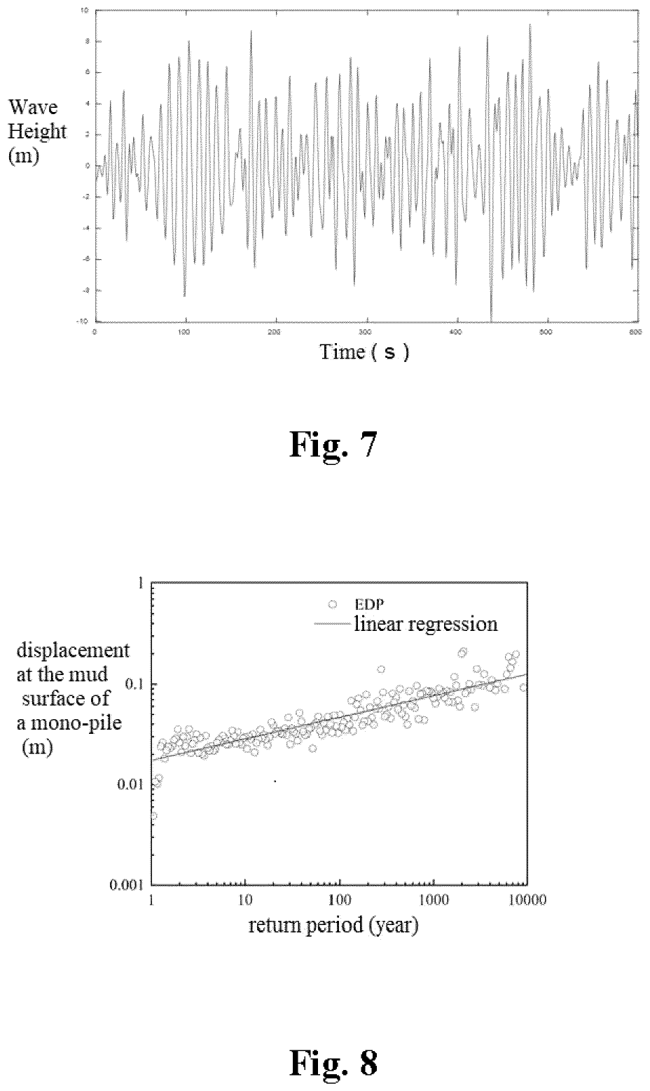

Obtaining a random wind-speed time course and a wave-surface time course by the harmonic wave superposition method to simulate an actual marine environment on basis of the wind-wave energy spectrum density function and the wind-wave characteristics data in different return periods in step (1); a design wind simulation frequency range is 0˜4π rad/s (revolutions/second), a wave simulation frequency range is 0.1˜1.1 rad/s, and a simulation time length for the wave-surface time course and the wind-speed time course is 600 s. FIG. 7 is a diagram showing the wave-surface time course in the case that the return period is 100 years.

(3) Calculating the wind-wave dynamic load acting on the wind turbine pile foundation according to the relevant domestic and foreign norms and on basis of the wave-surface time course and the wind-speed time course simulated in step (2), wherein the wind load should be divided into two parts, one is a wind load exerted on a vane stress surface, the other is a wind load exerted on a tower frame stress surface. Their calculation formulas are as follows.

$${F}_{wind , R} = \frac{1}{2} {ρ}_{a} {A}_{R} {C}_{T} {V}_{w , hub}^{2}$$

$${F}_{wind , T} = {\int }_{0}^{{h}_{t}} \frac{1}{2} {ρ}_{a} {{C}_{s} [ {V}_{w} ( z ) ]}^{2} D ( z ) dz$$

In the above formulas, F_{wind,R} represents a wind load exerted on a vane stress surface, C_{T} represents an axial conductivity coefficient, ρₐ represents an air density, set with a value as 1.293 kg/m³, A_{R} represents a vane-sweep area, V̅_{w,hub} represents a wind-speed time course acting at a wheel hub of a wind turbine; F_{wind,T} represents a wind load exerted on a tower frame stress surface, Cₛ represents a shape factor, set with a value as 1.2, D represents a tower width, z represents a distance between a tower frame and a water level. V_{w}(z) represents a wind-speed time course acting at a tower frame.

As for the wave load, providing that the action of the wave on the pillar is mainly caused by viscous effect and additional mass effect, that is, the wave force acting on the pillar is composed of two parts: one is an inertial force proportional to acceleration, and the other is a drag force proportional to the square of speed, according to the norms, a horizontal wave compound force F_{wave} acting on the entire pillar elevation of the mono-pile foundation of the offshore wind turbine is as follows.

$${F}_{Wave} = {\int }_{0}^{{d}_{w}} ( {f}_{D} + {f}_{I} ) dz = {\int }_{0}^{{d}_{w}} ( \frac{1}{2} {C}_{D} ρ {D}_{p} {u}_{x} \vert {u}_{x} \vert + {C}_{M} ρ \frac{π {D}_{p}^{2}}{4} \frac{\partial {u}_{x}}{\partial t} ) dz$$

In the above formula, f_{D} represents a drag force, Dₚ represents a pillar diameter, ρ represents a sea water density, uₓ represents a horizontal water particle motion speed, C_{D} represents a drag force coefficient, f₁ represents an inertial force and C_{M} represents an inertial force coefficient,

$$\frac{\partial {u}_{x}}{\partial t}$$

represents horizontal water particle motion acceleration; according to the “Harbor Hydrological Norm”, setting C_{D} as 1.2, C_{M} as 2.0.

(4) Randomly sampling rock-soil strength parameters at the site where the dynamic response results are generated, on basis of the rock-soil strength parameter statistics and coefficients of variation of pile foundation sites of offshore wind turbines, assuming that the mono-pile foundation is embedded in single-layer clay, the rock-soil undrained shear strength Sᵤ and the effective weight γ′ are set with mean values as 25 kPa and 7 kN/m³, the coefficients of variation of Sᵤ and γ′ are set as 0.3 and 0.05, respectively, assuming that both Sᵤ and γ′ conform to a normal distribution, randomly sampling a certain number of Sᵤ and γ′, and inputting the samples of the rock-soil strength parameters generated by random sampling into the nonlinear p-y curve model applicable to clay proposed by API, so as to estimate the lateral soil resistance of the pile foundation, the lateral bearing force pᵤ of the mono-pile foundation at any embedded depth X can be calculated by the following formulas.

$$\{ \begin{matrix}{p}_{u} = 3 {S}_{u} + {γ}^{′} X + J \frac{{S}_{u} X}{{D}_{p}} & for X < \frac{6 {D}_{p}}{\frac{{γ}^{′} D}{{S}_{u}} + J} \\ {p}_{u} = 9 {S}_{u} & for X \geq \frac{6 {D}_{p}}{\frac{{γ}^{′} D}{{S}_{u}} + J}\end{matrix}$$

In the above formulas, J represents an empirical coefficient, set with a value as 0.5 for clay, and the lateral soil resistance P of the mono-pile foundation will approach the bearing force pᵤ with the lateral deformation y of the pile, so as to effectively reflect the nonlinear characteristics of soil bodies during the deformation of the pile, that is a p-y curve, which are set with values according to the norms.

(5) According to the design parameters of the offshore wind turbine, tower frame and mono-pile foundation for the wind farm planned to construct, establishing the 3D finite element model of the offshore wind turbine, tower frame and mono-pile foundation, making discrete nonlinear springs with a spacing of 1 m replace the rock-soil bodies around the pile as resistance boundary conditions, and applying the wind-wave load formed in step (3) to the finite element model as load boundary conditions.

(6) Repeating steps (2)˜(5), and setting the load return periods under logarithmic conditions of equal spacing sampling as 200 points between 0 and 4 years, then combining 200 groups of rock-soil strength parameters obtained by random sampling to form 200 finite element calculation files for batch calculation, calculating the dynamic response results of the offshore wind turbine pile foundation under the conditions of 200 groups of given wind-wave loads and rock-soil strength parameters, that is 200 sets (IM, EDP). In this example, the displacement distance at the mud surface of the mono-pile foundation of the offshore wind turbine is taken as the engineering demand parameter.

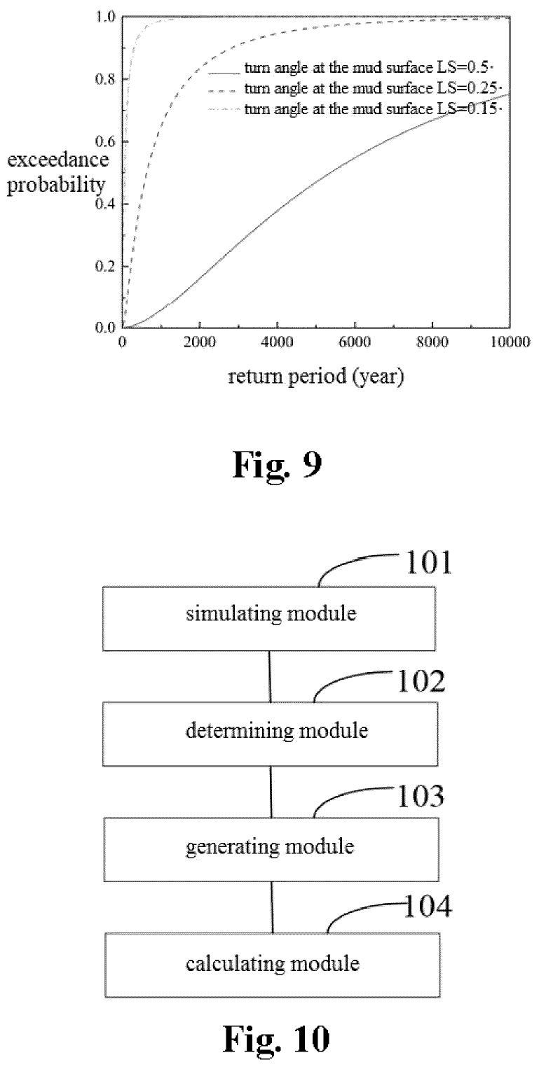

(7) Adopting a limit state of normal use for damage the mono-pile foundation of the offshore wind turbine, and taking the maximum turn angle at the mud surface of the mono-pile foundation as a limit state, wherein the turn angle at the mud surface can be equivalent to the horizontal displacement distance at the mud surface for the convenience of calculation. FIG. 8 shows horizontal displacement distances at the mud surface with 200 sets, a discrete distribution of return periods and a regression probability model, by way of performing linear regression, ln a and b are calibrated as −4.0517 and 0.2144, respectively, and μ ln(EDP|IM) is calibrated as 0.2705, based on the above parameters, the Cloud Analysis method is used to calculate a probability of exceeding the given limit state for its mono-pile foundation. FIG. 9 shows 3 given limit states of normal use, that is, an annual exceedance probability of this mono-pile foundation under wind-wave load conditions for a given return period, when the turn angles at the mud surface are 0.5°, 0.25° and 0.15°, respectively.

From this figure, it can be seen that based on the limit states of normal use for the mono-pile foundation, that is, when the maximum turn angle at the mud surface of the mono-pile foundation is 0.5′ as a limit state, the annual exceedance probability of the mono-pile foundation caused by the loads within the return period less than 100 years is small.

### Example 2

As shown in FIG. 10, an apparatus for evaluating vulnerability of mono-pile foundations of offshore wind turbines provided by this example includes the following steps.

A simulating module 101 used for collecting offshore wind farm location data and wind-wave characteristic data, and simulating a wind-wave time course according to the offshore wind farm location data and the wind-wave characteristic data; the above wind-wave time course including a wave-surface time course and a wind-speed time course.

Specifically, evaluating marine environmental conditions at the positions of the piles designed with mono-pile foundations, which mainly include the wind-wave characteristic data, and statistically obtaining the wind-wave characteristic data, such as an average wind-speed (V̅_{w,10}), for 10 minutes at a reference altitude and an effective wave height (Hₛ) of the wave statistics made for more than 3 hours, then establishing a relation between the return period (RP) of the wind-wave characteristic data and the wind-wave characteristic data such as V̅_{w,10} and Hₛ.

A determining module 102 used for determining a wind-wave dynamic load based on the above wind-wave time course; the above wind-wave dynamic load including a wave dynamic load and a wind dynamic load.
wherein, determining the above wind-wave dynamic load based on the above wave-surface time course, determining the above wind dynamic load based on the above wind-speed time course; the wind dynamic load is classified into a wind load exerted on a vane stress surface and a wind load exerted on a tower frame stress surface.

A generating module 103 used for obtaining lateral soil resistance data of mono-pile foundations with a plurality of rock-soil strength parameters, and inputting the above wind-wave dynamic load into a 3D finite element model, using the lateral soil resistance data of mono-pile foundations with a plurality of rock-soil strength parameters as boundary conditions of the above 3D finite element model, so as to generate a dynamic response result of mono-pile foundations.

Specifically, randomly sampling rock-soil strength parameters at the site where the dynamic response results are generated, on basis of the rock-soil strength parameter statistics and coefficients of variation of pile foundation sites of offshore wind turbines, then inputting the rock-soil strength parameter samples generated by randomly sampling into the nonlinear p-y curve method model proposed by the API norm (Rock-soil and Foundation Design Norm proposed by the American Petroleum Institute), so as to estimate the lateral soil resistance of pile foundations, and then obtain the lateral soil resistance data of mono-pile foundations with a plurality of rock-soil strength parameters; wherein the rock-soil strength parameters include rock-soil undrained shear strength Sᵤ, effective weight γ′, an internal friction angle ϕ, cohesion c and so on, and the rock-soil strength parameter statistics include a mean value μ of rock-soil strength parameters, a coefficient of variation (COV) and so on.

Further, in line of the design parameters of the offshore wind turbine and the substructure of a wind farm planned to be constructed, establishing a three-dimensional finite element model of offshore wind turbines, tower frames and mono-pile foundations, which is used to calculate and output the dynamic response results of mono-pile foundations, in order to improve calculation efficiency, estimating stiffness of springs on basis of the lateral soil resistance of pile foundations, and replacing the rock-soil body around the pile with discrete nonlinear springs as resistance boundary conditions, and then generating a series of intensity measures (IM), and a dynamic response result of mono-pile foundations of offshore wind turbines under the conditions of the rock-soil strength parameters (that is, a dynamic response result of mono-pile foundations), next taking the dynamic response result of mono-pile foundations as an engineering demand parameters (EDP) to generate a series of IM and EDP as a calibration database;

Wherein, the rock-soil strength parameters are generated by random sampling, so that uncertainty of marine soil is fully considered.

A calculating module 104 used for giving a limit state of mono-pile foundations, and determining vulnerability of mono-pile foundations on basis of the above dynamic response result of the mono-pile foundations and the above limit state of mono-pile foundations.

Specifically, according to norms or engineer's experience, giving a limit state (LS) of damage to mono-pile foundations of offshore wind turbines, such as a limit state of bearing capacity or a limit state of normal use, then calculating the vulnerability of the designed mono-pile foundation by the Cloud Analysis method, that is, a probability of exceeding the given limit state.

Further, estimating the engineering demand parameters (that is, the dynamic response results of mono-pile foundations) under the conditions of the given intensity measures (IM) on basis of a regression probability model by the Cloud Analysis method, wherein the intensity measures include wind-wave loads at different strength levels, and the engineering demand parameters include a turn angle at the mud surface of the mono-pile foundation, a horizontal displacement distance of the top of the tower frame and so on, then calibrating coefficients of the regression probability model on basis of the above intensity measures and engineering demand parameters; a calculation formula for the regression probability model is as follows

$$E [ ln ( EDP \vert IM ) ] = {μ}_{ln ( EDP \vert IM )} = ln a + b ln ( IM )$$

$${σ}_{ln ( EDP \vert IM )} = \sqrt{\frac{{\sum }_{i = 1}^{n} {[ ln {( EDP \vert IM )}_{i} - {μ}_{ln ( EDP \vert IM ) , i} ]}^{2}}{( n - 2 )}}$$

In the above formula, E[ln(EDP|IM)] represents a mathematical expectation of a natural logarithm of the engineering demand parameter under the conditions of a given intensity measure, simplified as μ ln(EDP|IM), ln a and b represent a unknown parameter to be calibrated, σ ln(EDP|IM) represents a standard deviation of a regression curve to be calibrated, ln(EDP|IM) represents a natural logarithm of the engineering demand parameter under the conditions of a given strength parameter, n represents a number of dynamic response results output by the finite element model of mono-pile foundations.

Further, D={[IMi,(EDP|IM)i], i=1:n}, minimizing a sum of squares of the deviation by the least squares method, and then calibrating the unknown parameters ln a, b and σ ln(EDP|IM), and inputting the calibrated the parameters ln a, b and σ ln(EDP|IM) to give an estimated value of the engineering demand parameter of mono-pile foundations of offshore wind turbines under the conditions of any given strength measure, and estimating a probability of exceeding a given limit state, that is the vulnerability of mono-pile foundations. The formula for calculating the above-mentioned vulnerability of mono-pile foundations is as follows.

$$P [ ln ( EDP ) > ln ( LS ) \vert IM , Coef ] = 1 - Φ [ \frac{ln ( LS ) - {μ}_{ln ( EDP \vert IM )}}{{σ}_{ln ( EDP \vert IM )}} ]$$

In the above formula, P represents vulnerability of mono-pile foundations, EDP represents a dynamic response result of mono-pile foundations, LS represents a limit state of mono-pile foundations, IM represents a wind-wave dynamic load, Coef represents a set of calibration parameters, Coef={ln a,b, σ ln(EDP|IM), Φ[·] represents a cumulative distribution function of standard normal distribution, μ ln(EDP|IM) represents a mathematical expectation of a natural logarithm of the dynamic response result of mono-pile foundations, σ ln(EDP|IM) represents a standard deviation of a regression curve to be calibrated.

In the above apparatus for evaluating vulnerability of mono-pile foundations of offshore wind turbines, it is achievable to simulate the wind-wave time course based on the offshore wind farm location data and the wind-wave characteristic data, and it is able to realistically simulate the sea conditions of mono-pile foundations of offshore wind turbines, and then determine the wind-wave dynamic load based on the wind-wave time course, and obtain the dynamic response of mono-pile foundations by using the wind-wave dynamic load, so as to accurately reflect the actual dynamic response of mono-pile foundations; in addition, it is achievable to use the lateral soil resistance data of mono-pile foundations with a plurality of rock-soil strength parameters as boundary conditions of the above 3D finite element model, and take the uncertainty of marine soil into consideration, and then calculate the vulnerability of mono-pile foundations, so as to makes the vulnerability analysis of mono-pile foundations more accurate; finally, it is able to intuitively calculate a failure probability of mono-pile foundations of offshore wind turbines at different strength load levels by using the 3D finite element model during a designed service period, that is vulnerability, and then provide reliable analysis data for mono-pile foundations in different application scenarios.

Preferably, the simulating module 101 includes.

A first simulating sub-module 1011 used for inputting the offshore wind farm location data and the wind-wave characteristic data into a preset energy spectrum density function to generate a wave-spectrum density function and a wind-speed spectrum density function.

Specifically, obtaining a random wind-speed time course and a wave-surface time course on basis of the wave-spectrum density function and the wind-speed spectrum density function by means of the harmonic superposition method, so as to simulate an actual marine environment, wherein the wind-speed time course and the wave-surface time course are essentially a random process in a time domain.

Wherein, since the wind-speed forms a wind-speed profile along elevations, there is coherence in the wind turbulence at each elevation, thus in order to take coherence of wind into consideration, we introduce a coherence coefficient. In the case of only taking vertical coherence into consideration, the coherence coefficient Cᵢⱼ is calculated as follows.

$${C}_{ij} = exp [ - \frac{{ω}_{i} {C}_{z} \vert {z}_{i} - {z}_{j} \vert}{2 π {\overline{V}}_{w , 10} ( {z}_{i} )} ]$$

In the formula, zᵢ and zⱼ represent simulations to the elevations at point i and point j (that is, wind-wave characteristic data) in the wind-speed time course in the case of taking coherence of wind into consideration, respectively.

Further, in the case of introducing the above coherence coefficient Cᵢⱼ, we can calculate a wind energy spectrum density function at multiple points through the following formula.

$${S}_{w , ij} ( ω ) = \sqrt{{S}_{w , ii} ( ω ) {S}_{w , jj} ( ω )} {C}_{ij}$$

$${S}_{w , ij} ( ω ) = \sqrt{{S}_{w , ii} ( ω ) {S}_{w , jj} ( ω )} {C}_{ij}$$

In the formula, S_{W,ij(w)} represents a cross-power spectrum density function used to take correlation of each wind-speed simulation point into consideration; S_{w,ij(w)} represents an auto-power spectrum density function at point i, and S_{w,ij(w)} represents an auto-power spectrum density function at point j.

A second simulating sub-module 1012 used for obtaining a wave initial phase position and a wave frequency, and generating the wave-surface time course by using the wave initial phase position, the wave frequency and the wave-spectrum density function.

A third simulating sub-module 1013 used for obtaining a wind-speed initial phase position and a wind-speed frequency, and generating the wind-speed time course by using the wind-speed initial phase position, the wind-speed frequency and the wind-speed spectrum density function.

Preferably, the second simulating sub-module 1012 includes:

A first equally-dividing unit 10121 used for extracting an angular frequency range from the above wave-spectrum density function and equally dividing the above angular frequency range into multiple wave frequency intervals.

Specifically, providing that the angular frequency range ω_{L}˜ω_{H} is extracted from the wave-spectrum density function, dividing the angular frequency range into N₁ intervals (that is, wave frequency intervals), and setting N₁ as an appropriate positive integer (not less than 1000).

A first determining unit 10122 used for determining a wave equal interval on basis of a upper limit and a lower limit of the angular frequency range and a number of the wave frequency intervals.

Specifically, the formula for calculating the wave equal interval Δω₁ is as follows.

$${Δω}_{1} = ( {ω}_{H} - {ω}_{L} ) / {N}_{1} = {ω}_{i + 1} - {ω}_{i}$$

In the above formula, ω_{H} represents a upper of an angular frequency range, ω_{L} represents a lower limit of an angular frequency range, ωᵢ˜ω₍ᵢ₊₁₎ represents a wave frequency interval.

A first obtaining unit 10123 used for determining the wave-surface time course on basis of the wave initial phase position, the wave frequency, the wave equal interval and the wave-spectrum density function.

Wherein, as for the simulation to the wave-surface time course, a wave surface expression at a fixed point is as follows according to a sea wave model.

$$η ( t ) = {\sum }_{n = 1}^{∞} {a}_{n} cos ( {ω}_{n} t + {ε}_{n} )$$

In the above formula, aₙ represents a wave amplitude, ωₙ represents an angular wave frequency, εₙ represents an initial phase position evenly distributed between 0˜2π, t represents simulation time.

Further, providing that the wave-spectrum density function to be simulated is S_{η}(ω), and in order to avoid periodicity, a random number ŵᵢ is arbitrarily selected from ωᵢ˜ω₍ᵢ₊₁₎ as a frequency of the i^{th} composition wave, superimposing N₁ cosine waves representing wave energy of N₁ intervals, that is, obtaining a simulated wave-surface time course on basis of the harmonic wave superposition principle.

$$η ( t ) = {\sum }_{i = 1}^{N} \sqrt{2 {S}_{η} ( {\hat{ω}}_{i} ) Δω} cos ( {\hat{ω}}_{i} t + {ε}_{i} )$$

It should be noted that this wave-surface time course is a random process, in which different results will be sampled at each time of simulations made in a given time domain.

Preferably, the third simulating sub-module 1013 includes:

A second equally-dividing unit 10131 used for extracting a pulsating wind frequency range and a wind-speed argument from the above wind-speed spectrum density function and dividing the above pulsating wind frequency range into multiple wind-speed frequency intervals.

Specifically, dividing the pulsating wind frequency range into N₂ (not less than 1000) wind-speed frequency intervals, wherein N₂ represents a number of wind-speed frequency intervals.

A second determining unit 10132 used for determining a wind-speed equal interval on basis of a upper limit and a lower limit of the above pulsating wind frequency range and a number of wind-speed frequency intervals.

Specifically, the formula for calculating the wind-speed equal interval Δω₂ is as follows.

$${Δω}_{2} = ( {ω}_{u} - {ω}_{l} ) / {N}_{2}$$

In the above formula, ωᵤ represents a upper of a pulsating wind frequency range, ωₗ represents a lower limit of a pulsating wind frequency range.

A second obtaining unit 10133 used for determining the wind-speed time course on basis of the wind-speed initial phase position, the wind-speed frequency, the wind-speed argument, the wind-speed equal interval and the wind-speed spectrum density function.

Specifically, providing that the wind-speed spectrum density function to be simulated is S_{w}(ω), the formula for calculating the wind-speed time course is as follows on basis of the harmonic wave superposition principle.

$${V}_{w} ( t ) = \sqrt{2 ( Δω )} {\sum }_{m = 1}^{j} {\sum }_{l = 1}^{N} \vert {H}_{jm} ( {\hat{ω}}_{ml} ) \vert cos [ {\hat{ω}}_{ml} t + {θ}_{jm} ( {\hat{ω}}_{ml} ) + {ε}_{ml} ]$$

In the above formula, j represents a number of simulation points of the wind-speed time course, ωₘₗ˜wₘ (l+1) represents a wind-speed frequency range, from which a random number ωₘₗ is arbitrarily selected as the l^{th} wind spectrum composition frequency at the m^{th} simulation point, Hⱼₘ(ω) represents the Cholesky decomposition of the power spectrum density function S_{w}(ω) (the Cholesky decomposition is to express a symmetrical positive definite matrix as a lower triangular matrix L and decompose a product of its transposition). Its calculation formula is as follows.

S_{w,jm}(ω)=Hⱼₘ(ω)Hⱼₘ^{T}(ω)

In the above formula, Hⱼₘ^{T}(ω) represents a transposed matrix of Hⱼₘ(ω).

Further, θⱼₘ(ω) represents an argument of Hⱼₘ(ω), its calculation formula is as follows.

$${θ}_{jm} ( ω ) = arctan \{ \frac{Im [ {H}_{jm} ( ω ) ]}{Re [ {H}_{jm} ( ω ) ]} \}$$

Preferably, the determining module 102 includes:

An obtaining sub-module 1021 used for obtaining an air density, a vane-sweep area and an axial conductivity coefficient, and determining a wind load exerted on a vane stress surface on basis of the air density, the vane-sweep area, the axial conductivity coefficient and the wind-speed time course.

Wherein, the wind load exerted on a vane stress surface is calculated by the following formula.

$${F}_{wind , R} = \frac{1}{2} {ρ}_{a} {A}_{R} {C}_{T} {V}_{w , hub}^{2}$$

In the above formula, F_{wind,R} represents a wind load exerted on a vane stress surface, C_{T} represents an axial conductivity coefficient, ρₐ represents an air density, A_{R} represents a vane-sweep area, V_{w,hub} represents a wind-speed time course acting at a wheel hub of a wind turbine.

A determining sub-module 1022 used for obtaining a shape factor and a tower width, and determining a wind load exerted on a tower frame stress surface on basis of the air density, the shape factor, the tower width, and the wind-speed time course.

Wherein, the wind load exerted on a tower frame stress surface is calculated by the following formula.

$${F}_{wind , T} = {\int }_{0}^{{h}_{t}} \frac{1}{2} {ρ}_{a} {{C}_{s} [ {V}_{w} ( z ) ]}^{2} D ( z ) dz$$

In the above formula, F_{wind,T} represents a wind load exerted on a tower frame stress surface, Cₛ represents a shape factor, D represents a tower width, z represents a distance between a tower frame and a water level, V_{w}(Z) represents a wind-speed time course acting at a tower frame.

A calculating sub-module 1023 used for generating the above wind dynamic load on basis of the above wind load exerted on a vane stress surface and the above wind load exerted on a tower frame stress surface.

Specifically, adding the above wind load exerted on a vane stress surface to the above wind load exerted on a tower frame stress surface, so as to generate the wind dynamic load.

Preferably, the determining module 102 further includes:
obtaining a drag force, a pillar diameter, a sea water density, a horizontal water particle motion speed, a drag force coefficient, an inertial force and an inertial force coefficient, and determining the wave dynamic load on basis of the wave-surface time course, the drag force, the pillar diameter, the sea water density, the horizontal water particle motion speed, the drag force coefficient, the inertial force and the inertial force coefficient.

Specifically, providing that the action of the wave on the pillar is mainly caused by viscous effect and additional mass effect, that is, the wave force acting on the pillar is composed of two parts: one is an inertial force proportional to acceleration, and the other is a drag force proportional to the square of speed, thus the wave dynamic load is calculated by the following formula.

$${F}_{Wave} = {\int }_{0}^{{d}_{w}} ( {f}_{D} + {f}_{I} ) dz = {\int }_{0}^{{d}_{w}} ( \frac{1}{2} {C}_{D} ρ {D}_{p} {u}_{x} \vert {u}_{x} \vert + {C}_{M} ρ \frac{π {{D}_{p}}^{2}}{4} \frac{\partial {u}_{x}}{\partial t} ) dz$$

In the above formula, f_{D} represents a drag force, Dₚ represents a pillar diameter, ρ represents a sea water density, [symbol] _{X} represents a horizontal water particle motion speed, C_{D} represents a drag force coefficient, f₁ represents an inertial force and C_{M} represents an inertial force coefficient,

$$\frac{\partial {u}_{x}}{\partial t}$$

represents horizontal water particle motion acceleration.

Wherein, based on the linear wave theory, the formula for calculating the horizontal water particle motion speed [symbol] _{X} is as follows.

$${u}_{x} = \frac{2 π}{T} \frac{cosh kz}{sinh {kd}_{w}} η$$

In the above formula, k represents a number of waves, η represents a wave-surface time course, d_{w} represents a water depth, T represents a wave cycle.

Wherein, the formula for calculating horizontal water particle motion acceleration

$$\frac{\partial {u}_{x}}{\partial t}$$

is as follows

$$\frac{\partial {u}_{x}}{\partial t} = \frac{4 {π}^{2}}{{T}^{2}} \frac{cosh kz}{sinh {kd}_{w}} ηtan ( \frac{2 π t}{T} - kx )$$

In the above formula, t represents a simulation time length for the wave-surface time course, X represents a position of the simulation point.

Furthermore, it is able to obtain the wind-wave dynamic loads during different return periods of the wind-wave characteristic data on basis of the relation between the return periods of the above-mentioned wind-wave characteristic data and the wind-wave characteristic data such as V̅_{w,10} and Hₛ by adopting the above processing method.

### Example 3

This example proposes a computer device, which includes a processor and a memory, the processor is used to read instructions stored in the memory to execute the method for evaluating vulnerability of monopile foundations of offshore wind turbines mentioned in any above embodiments.

A person skilled in the art should understand that the examples of the present invention may be provided as a process, system, or computer program product. Therefore, the present invention may be embodied in a form of complete hardware, complete software, or a combination of software and hardware. In addition, the present invention may be embodied in a form of a computer program product executed on one or more computer-available storage media (including, but not limited to, a disk memory, a CD-ROM, an optical memory, etc.) containing computer-available program codes.

The present invention is described with reference to a flowchart and/or block diagram of a method, apparatus (system), and computer program product according to the examples of the present invention. It should be understood that computer program instructions can execute each process and/or block in the flowchart and/or block diagram, as well as a combination of the process and/or block in the flowchart and/or block diagram. These computer program instructions may be provided to processors of a general-purpose computer, a specialized computer, an embedded processing machine, or other programmable data processing devices to generate a machine, so that the instructions executed by the processors of the computer or other programmable data processing devices generates an apparatus used to achieve the functions specified in one or more processes of the flowchart and/or one or more blocks of the block diagram.

These computer program instructions may also be stored in a computer-readable memory capable of directing a computer or other programmable data-processing device to operate in a particular manner, so that the instructions stored in the computer-readable memory generate a manufactured product containing an instruction apparatus achieves the functions specified in one or more processes of the flowchart and/or one or more blocks of the block diagram.

These computer program instructions may also be loaded onto a computer or other programmable data processing devices, so that a series of operational steps are executed on the computer or other programmable devices to generate a process executed by the computer, so as to enable the instructions executed on the computer or other programmable devices to provide a step used to achieve the functions specified in one or more processes of the flowchart and/or one or more blocks of the block diagram.

### Example 4

This example provides a computer-readable storage medium, the computer storage medium stores a computer-executable instruction, and the computer-executable instruction can execute the method for evaluating vulnerability of monopile foundations of offshore wind turbines mentioned in any above embodiments. Wherein, the storage medium may be a disk, an optical disk, a read-only memory (ROM), a random-access memory (RAM), a flash memory, a hard disk (HDD) or a solid-state drive (SSD); the storage medium may also include a combination of the above memories.

Obviously, the above examples are only used as instances to clearly describe the present invention and not pose any limitations on the embodiments. A person skilled in the art can make other changes or modification on the basis of the above description, but he/she has no need and no ability to enumerate all embodiments Therefore, the obvious changes or modifications derived therefrom still fall within the protection scope of the present invention.

1. A method for evaluating vulnerability of monopile foundations of offshore wind turbines, comprising the steps of
collecting offshore wind farm location data and wind-wave characteristic data, and simulating a wind-wave time course according to the offshore wind farm location data and the wind-wave characteristic data; the wind-wave time course including a wave-surface time course and a wind-speed time course;
determining a wind-wave dynamic load based on the wind-wave course; the wind-wave dynamic load including a wave dynamic load and a wind dynamic load;
obtaining lateral soil resistance data of monopile foundations with a plurality of rock-soil strength parameters, and inputting the wind-wave dynamic load into a 3D finite element model; using the lateral soil resistance data of monopile foundations with a plurality of rock-soil strength parameters as boundary conditions of the 3D finite element model, so as to generate a dynamic response result of monopile foundations; and
giving a limit state of monopile foundations, and determining vulnerability of monopile foundations on basis of the dynamic response result of monopile foundations and the limit state of monopile foundations;
wherein the step of simulating a wind-wave time course according to the offshore wind farm location data and the wind-wave characteristic data comprises the sub-steps of
inputting the offshore wind farm location data and the wind-wave characteristic data into a preset energy spectrum density function to generate a wave-spectrum density function and a wind-speed spectrum density function;
obtaining a wave initial phase position and a wave frequency, and generating the wave-surface time course by using the wave initial phase position, the wave frequency and the wave-spectrum density function; and
obtaining a wind-speed initial phase position and a wind-speed frequency, and generating the wind-speed time course by using the wind-speed initial phase position, the wind-speed frequency and the wind-speed spectrum density function;
wherein the sub-step of generating the wave-surface time course by using the wave initial phase position, the wave frequency and the wave-spectrum density function comprises the sub-steps of
extracting an angular frequency range from the wave-spectrum density function and equally dividing the angular frequency range into multiple wave frequency intervals;
determining a wave equal interval on basis of a upper limit and a lower limit of the angular frequency range and a number of the wave frequency intervals; and
determining the wave-surface time course on basis of the wave initial phase position, the wave frequency, the wave equal interval and the wave-spectrum density function.

2. The method for evaluating vulnerability of monopile foundations of offshore wind turbines according to claim 1, wherein the sub-step of generating the wind-speed time course by using the wind-speed initial phase position, the wind-speed frequency and the wind-speed spectrum density function comprises the sub-steps of
extracting a pulsating wind frequency range and a wind-speed argument from the wind-speed spectrum density function and dividing the pulsating wind frequency range into multiple wind-speed frequency intervals;
determining a wind-speed equal interval on basis of a upper limit and a lower limit of the pulsating wind frequency range and a number of wind-speed frequency intervals; and
determining the wind-speed time course on basis of the wind-speed initial phase position, the wind-speed frequency, the wind-speed argument, the wind-speed equal interval and the wind-speed spectrum density function.

3. The method for evaluating vulnerability of monopile foundations of offshore wind turbines according to claim 1, wherein the step of determining a wind-wave dynamic load based on the wind-wave course comprises the sub-steps of
obtaining an air density, a vane-sweep area and an axial conductivity coefficient, and determining a wind load exerted on a vane stress surface on basis of the air density, the vane-sweep area, the axial conductivity coefficient and the wind-speed time course;
obtaining a shape factor and a tower width, and determining a wind load exerted on a tower frame stress surface on basis of the air density, the shape factor, the tower width, and the wind-speed time course; and
generating the wind dynamic load on basis of the wind load exerted on a vane stress surface and the wind load exerted on a tower frame stress surface.

4. The method for evaluating vulnerability of monopile foundations of offshore wind turbines according to claim 3, wherein the step of determining a wind-wave dynamic load based on the wind-wave course further comprises:
obtaining a drag force, a pillar diameter, a sea water density, a horizontal water particle motion speed, a drag force coefficient, an inertial force and an inertial force coefficient, and determining the wave dynamic load on basis of the wave-surface time course, the drag force, the pillar diameter, the sea water density, the horizontal water particle motion speed, the drag force coefficient, the inertial force and the inertial force coefficient.

5. The method for evaluating vulnerability of monopile foundations of offshore wind turbines according to claim 1, wherein in the step of determining vulnerability of monopile foundations on basis of the dynamic response result of monopile foundations and the limit state of monopile foundations, a formula for calculating the vulnerability of monopile foundations is as follows:
$$P [ ln ( EDP ) > ln ( LS ) \vert IM , Coef ] = 1 - Φ [ \frac{ln ( LS ) - {μ}_{ln ( EDP \vert IM )}}{{σ}_{ln ( EDP \vert IM )}} ]$$
in the formula, P[·] represents vulnerability of monopile foundations, EDP represents a dynamic response result of monopile foundations, LS represents a limit state of monopile foundations, IM represents a wind-wave dynamic load, Coef represents a set of calibration parameters, Φ[·] represents a cumulative distribution function of standard normal distribution, μ ln(EDP|IM) represents a mathematical expectation of a natural logarithm of the response result of monopile foundations, σ ln(EDP|IM) represents a standard deviation of a regression curve to be calibrated.

6. An apparatus for evaluating vulnerability of monopile foundations of offshore wind turbines, comprising:
a simulating module used for collecting offshore wind farm location data and wind-wave characteristic data, and simulating a wind-wave time course according to the offshore wind farm location data and the wind-wave characteristic data; wherein the wind-wave time course comprises a wave-surface time course and a wind-speed time course;
a determining module used for determining a wind-wave dynamic load based on the wind-wave course; wherein the wind-wave dynamic load includes a wave dynamic load and a wind dynamic load;
a generating module used for obtaining lateral soil resistance data of monopile foundations with a plurality of rock-soil strength parameters, and inputting the wind-wave dynamic load into a 3D finite element model; using the lateral soil resistance data of monopile foundations with a plurality of rock-soil strength parameters as boundary conditions of the 3D finite element model, so as to generate a dynamic response result of monopile foundations; and
a calculating module used for giving a limit state of monopile foundations, and determining vulnerability of monopile foundations on basis of the dynamic response result of monopile foundations and the limit state of monopile foundations;
wherein the simulating module comprises:
a first simulating sub-module used for inputting the offshore wind farm location data and the wind-wave characteristic data into a preset energy spectrum density function to generate a wave-spectrum density function and a wind-speed spectrum density function;
a second simulating sub-module used for obtaining a wave initial phase position and a wave frequency, and generating the wave-surface time course by using the wave initial phase position, the wave frequency and the wave-spectrum density function; and
a third simulating sub-module used for obtaining a wind-speed initial phase position and a wind-speed frequency, and generating the wind-speed time course by using the wind-speed initial phase position, the wind-speed frequency and the wind-speed spectrum density function;
wherein the second simulating sub-module comprises:
a first equally-dividing unit used for extracting an angular frequency range from the wave-spectrum density function and equally dividing the angular frequency range into multiple wave frequency intervals;
a first determining unit used for determining a wave equal interval on basis of a upper limit and a lower limit of the angular frequency range and a number of the wave frequency intervals; and
a first obtaining unit used for determining the wave-surface time course on basis of the wave initial phase position, the wave frequency, the wave equal interval and the wave-spectrum density function.

7-8. (canceled)
